(19) United States
(12) Patent Application Publication
(10) Pub. No.: US 2024/0102808 A1
(43) Pub. Date: Mar. 28, 2024

(54) INDOOR NAVIGATION USING DISPLAY DEVICES

(71) Applicant: Cisco Technology, Inc., San Jose, CA (US)

(72) Inventors: Cecilia Rose Mapes, Morrisville, NC (US); Wayne E. Moorefield, JR., Apex, NC (US); Vikas Vashisht, Morrisville, NC (US)

(21) Appl. No.: 17/951,912

(22) Filed: Sep. 23, 2022

(51) Int. Cl. G01C 21/20

(52) U.S. Cl. CPC G01C 21/206

(57) ABSTRACT

Techniques are provided for indoor navigation using display devices. In one example, a server obtains, from a user device, an indication that a user of the user device is attempting to navigate to a target location in a building. In response to the indication that the user is attempting to navigate to the target location in the building, the server provides, to respective display devices in the building, a unique identifier associated with the user. When the respective display devices obtain the unique identifier from the user device, the respective display devices display respective navigational information to guide the user from respective locations of the respective display devices to the target location.

### TECHNICAL FIELD

The present disclosure relates to indoor navigation.

### BACKGROUND

Many people have trouble finding a specific room in a building. They might, for example, be unfamiliar with the building layout or have difficulty with spatial reasoning. This can cause undue frustration and/or tardiness for the people trying to find the room as well as for anyone they might be meeting.

### BRIEF DESCRIPTION OF THE DRAWINGS

FIG. 1 illustrates an indoor environment suitable for user navigation to a target location, according to an example embodiment.

FIG. 2 illustrates a system configured for indoor navigation using display devices, according to an example embodiment.

FIG. 3 illustrates a sequence diagram showing the order and timing for operations associated with indoor navigation using display devices, according to an example embodiment.

FIGS. 4A-4C illustrate respective displays configured to guide one or more users to one or more target locations, according to an example embodiment.

FIG. 5 illustrates a hardware block diagram of a computing device configured to perform functions associated with operations discussed herein, according to an example embodiment.

FIG. 6 illustrates a flowchart of a method for performing functions associated with operations discussed herein, according to an example embodiment.

### DETAILED DESCRIPTION

### Overview

Techniques are provided herein for indoor navigation using display devices. In one example embodiment, a server obtains, from a user device, an indication that a user of the user device is attempting to navigate to a target location in a building. In response to the indication that the user is attempting to navigate to the target location in the building, the server provides, to respective display devices in the building, a unique identifier associated with the user. When the respective display devices obtain the unique identifier from the user device, the respective display devices display respective navigational information to guide the user from respective locations of the respective display devices to the target location.

### Example Embodiments

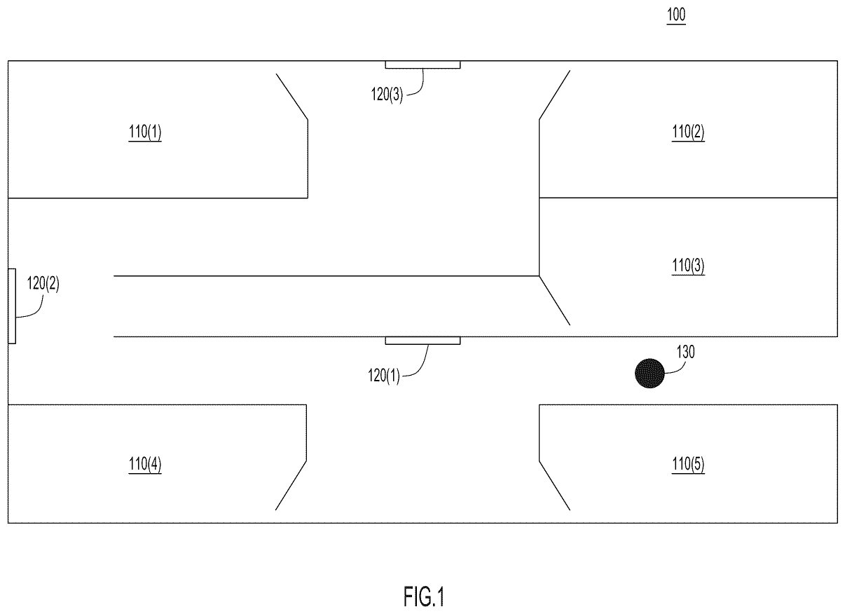

FIG. 1 illustrates an indoor environment 100 suitable for user navigation to a target location, according to an example embodiment. Indoor environment 100 may be a floor of a building, such as an open space/open-plan office. As shown, indoor environment 100 includes rooms 110(1)-110(5) and display devices 120(1)-120(3). Display devices 120(1)-120(3) may be any suitable devices (e.g., bespoke devices) with a display (e.g., screen) that are visible to users walking on the floor. Display devices 120(1)-120(3) may be collaboration devices having fixed positions and orientations on the floor. Examples of display devices 120(1)-120(3) may include Cisco Systems, Inc.'s Webex Room Navigator devices, Webex Desk Pro devices, etc.

In this example, user 130 may be a first-time visitor to the floor (e.g., an office space) and may be attempting to navigate to room 110(1) (e.g., a conference room) for a meeting. Conventionally, user 130 would wander the floor searching for room 110(1), possibly stopping at each of rooms 110(2)-110(5) and taking several wrong turns, before finally reaching room 110(1). User 130 may have trouble finding room 110(1) even with conventional tools like physical maps or indoor Global Positioning System (GPS) navigation. Physical maps of a floor are often limited to fire plans, lacking actual room numbers, or restricted to a small number of locations (e.g., only one near each entrance). Furthermore, indoor GPS navigation can be inaccurate without additional deployment, and the user interface is typically limited to the small screen of a phone.

Accordingly, techniques are provided herein to assist user 130 in promptly navigating to room 110(1). In one example, user 130 may input, into an application on a user device (e.g., a smartphone), a target location—here, room 110(1). For instance, user 130 may select room 110(1) by searching room information (e.g., room name/number) or by selecting room 110(1) from a list on candidate rooms in the application. In another example, the target location may be extracted automatically from a user calendar (e.g., based on timing). For instance, the application may request a user confirmation that user 130 has a meeting scheduled in room 110(1) in fifteen minutes (for example).

Once the search for room 110(1) has been initiated/confirmed by user 130, the user device may launch the process for assisting user 130 in navigating to room 110(1). In one example, the user device may coordinate with display devices 120(1)-120(3) to guide user 130 to room 110(1). When user 130 is in proximity to one or more of display devices 120(1)-120(3), the user device may send metadata (e.g., a unique identifier) to the one or more display devices. The one or more display devices may respond by showing navigational information to guide user 130 to room 110(1).

Display devices 120(1)-120(3) may display directions with respect to the physical space, such as arrows pointing toward the path to room 110(1). User 130 may navigate through the floor using display devices 120(1)-120(3) as signposts/aids which facilitate navigation that is more natural than map-based wayfinding and can be processed by user 130 at a glance. Thus, user 130 may use a custom application in combination with display devices 120(1)-120(3) to obtain just-in-time navigational information tailored for user 130.

For example, after user 130 inputs room 110(1) into the application, user 130 may proceed toward room 110(1), with the user device connecting to and broadcasting the unique identifier to display devices 120(1)-120(3). Display devices 120(1)-120(3) may each display up-to-date navigational information when user 130 is in proximity thereto. First, user 130 may proceed to display device 120(1), which may display an arrow pointing to the left. Second, user 130 may proceed to display device 120(2), which may display an arrow pointing to the right. Third, user 130 may proceed to display device 120(3), which may display an arrow pointing to the left. By following each arrow, user 130 may arrive at room 110(1) without being diverted to rooms 110(2)-110(5). In one example, once user 130 reaches room 110(1), a display device inside or just outside room 110(1) may display an indication that user 130 has arrived at the target location.

Additionally/alternatively, display devices 120(1)-120(3) may display navigational information including a floor map. Display devices 120(1)-120(3) may display the floor map when user 130 is in proximity thereto. The floor map may include “you are here” and “your room is there” indications.

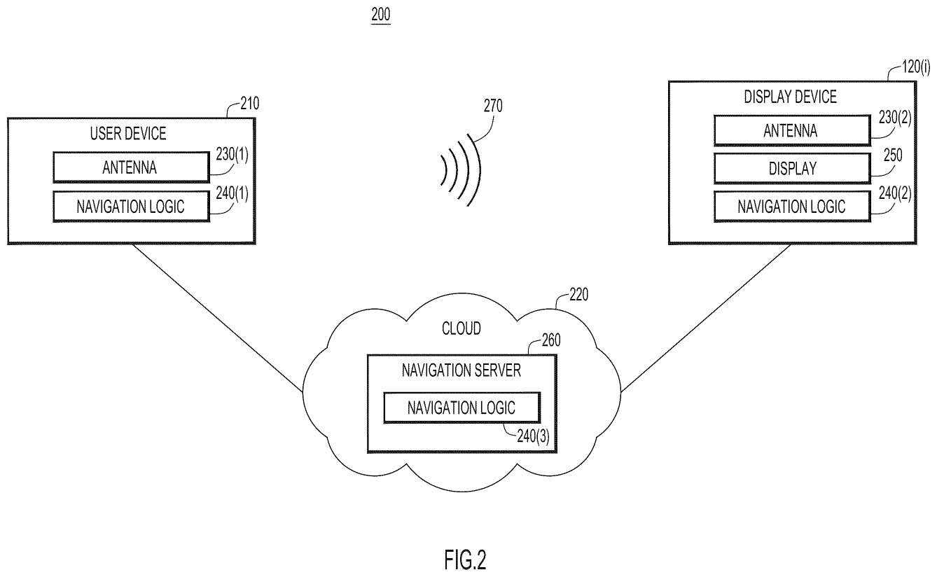

With continuing reference to FIG. 1, FIG. 2 illustrates a system 200 configured for indoor navigation using display devices, according to an example embodiment. System 200 includes user device 210, display device 120(i), and cloud (e.g., backend) 220. User device 210 (e.g., a smartphone, tablet, etc.) includes antenna 230(1) and navigation logic 240(1). Display device 120(i) (e.g., one of display devices 120(1)-120(3)) may include antenna 230(2), display 250, and navigation logic 240(2). Cloud 220 may include navigation server 260, which may in turn include navigation logic 240(3).

Antennas 230(1) and 230(2) may enable user device 210 and display device 120(i) to wirelessly communicate with each other and/or with cloud 220. Navigation logic 240(1)-240(3) may enable system 200 to perform techniques described herein in connection with assisting user 130 in navigating to room 110(1). For example, navigation logic 240(3) may enable navigation server 260 to provide a navigation service to user 130.

In one example, navigation server 260 may obtain, from user device 210, an indication that user 130 is attempting navigate to a target location in a building. In response, navigation server 260 may provide, to display device 120(i) (e.g., one of display devices 120(1)-120(3)), a unique identifier associated with user 130. When display device 120(i) obtains the unique identifier from user device 210 (as represented by wireless signal 270), display device 120(i) may display (e.g., on display 250) navigational information to guide user 130 from the location of display device 120(i) to the target location (e.g., room 110(1)).

Wireless signal 270 may be transmitted via Bluetooth® Low Energy (BLE), Wi-Fi®, ultrasound, or any other suitable wireless communication technology. As a result, the unique identifier may be sent to display device 120(i) via a BLE beacon, Wi-Fi transmission, ultrasound signal, etc. The unique identifier may be any suitable identifier that uniquely (locally or globally) corresponds to user 130. The unique identifier may be, for example, an alphanumeric sequence, a sequence of bits, etc.

The unique identifier may be generated by cloud 220 or user device 210. If the unique identifier is generated by cloud 220, user device 210 may provide the initial request for assistance in finding the target location, and cloud 220 may generate the unique identifier and distribute it to display devices 120(1)-120(3) (e.g., display device 120(i)). If the unique identifier is generated by user device 210, user device 210 may include the unique identifier with the initial request to cloud 220, and cloud 220 may pass along the unique identifier to display device 120(i).

Display device 120(i) may obtain the unique identifier from user device 210 when user device 210 is in wireless communication proximity to display device 120(i). As used herein, “wireless communication proximity” means a physical distance within which user device 210 may communicate wirelessly with display device 120(i) (e.g., 2-5 meters). The physical distance may be a distance at which user 130 can see the navigational information on display 250. This may ensure that user 130 is close enough to display 250 to see the navigational information displayed, while preventing the navigational information from being unnecessarily displayed at other display devices in the building that are not near user 130 and could therefore be used by other users instead. It will be appreciated that the wireless communication proximity may correspond to any suitable physical distance.

In a further example, display device 120(i) may clear the navigational information from display 250 when user device 210 moves away from display device 120(i). User device 210 moving away from display device 120(i) may indicate that user 130 has observed/consumed the navigational information and is proceeding toward the target location or the next display device, meaning that user 130 no longer requires the navigational information to be displayed. In one example, display device 120(i) may repeatedly ping user device 210 and monitor the responses obtained from user device 210 to determine whether user device 210 is moving away from display device 120(i).

By clearing the navigational information when user device 210 moves away from display device 120(i), display device 120(i) may ensure that the navigational information is displayed no longer than required by user 130. This may be helpful in case multiple users are seeking respective directions from display device 120(i) simultaneously (or near-simultaneously). In this case, the multiple users might otherwise need to wait for display device 120(i) to display their respective navigational information before proceeding to their target location(s).

It will be appreciated that, instead of clearing the navigational information when user device 210 moves away from display device 120(i), display device 120(i) may clear the navigational information from display 250 after a predetermined amount of time (e.g., three seconds). In some examples, the predetermined amount of time may vary depending on the expected number of users at a given time. For instance, the predetermined amount of time may increase or decrease based on projected building foot traffic, which may be estimated (e.g., by a machine-learning algorithm) from historical foot traffic data. Or, the predetermined amount of time may be smaller during regular business hours (when more user are expected to seek assistance in navigating to respective target locations), and larger at other times (when there are fewer expected users). The predetermined amount of time may also increase during periods of high room activity (e.g., in the ten minutes before one or more room reservations begin). The predetermined amount of time may be determined by any suitable device (e.g., user device 210, display device 120(i), cloud 220, etc.).

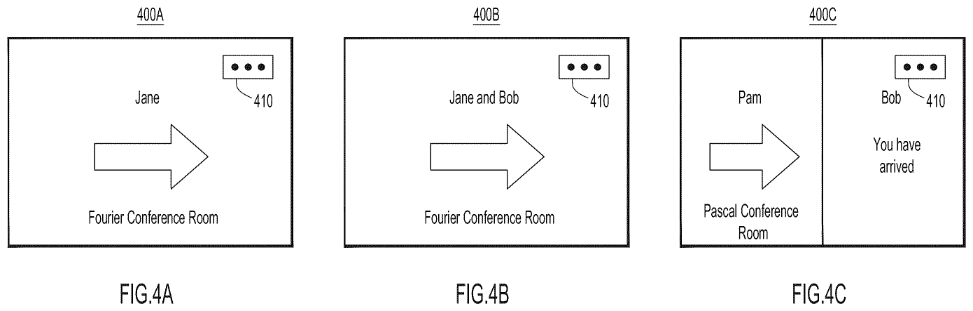

As discussed in greater detail below in connection with FIG. 4C, display device 120(i) may display navigational information for multiple people at once via a split-screen view. As a result, respective navigational information may be displayed for multiple users simultaneously without controlling when the navigational information is displayed or cleared based on the wireless communication proximity or whether a user is moving away from display device 120(i). However, such control may be beneficial even when a split-screen view option is employed because it may maximize the time during which the navigational information can be shown in full-screen on display 250 for easy viewing.

Display device 120(i) or cloud 220 may determine the navigational information to be displayed at display device 120(i). In one example, display device 120(i) is configured to determine the navigational information based on an indication of the target location provided from cloud 220 to display device 120(i). That is, display devices 120(1)-120(3) may each locally determine their respective navigational information to be displayed. In another example, in response to the indication that user 130 is attempting to navigate to the target location in the building, cloud 220 may determine the navigational information and provide the navigational information to display device 120(i). In this example, cloud 220 may determine the respective navigational information for displays 120(1)-120(3) and provide the respective navigational information to displays 120(1)-120(3).

In either case, the navigational information may be determined before the user device 210 sends wireless signal 270 to display device 120(i). This may enable display device 120(i) to quickly surface the navigational information upon receiving wireless signal 270. Furthermore, display device 120(i) or cloud 220 may determine the navigational information based on positioning information such as the location and orientation of display device 120(i) and an indoor map of the floor/building. Accordingly, display device 120(i) and/or cloud 220 may store or have access to the positioning information.

With continuing reference to FIGS. 1 and 2, FIG. 3 illustrates a sequence diagram 300 showing the order and timing for operations associated with indoor navigation using display devices, according to an example embodiment. At operation 305, user device 210 provides a navigation request/query to navigation server 260. The navigation request may be initiated by user 130 via an application of user device 210. The navigation request may indicate that user 130 is attempting to navigate to a target location in a building (e.g., room 110(1)). The navigation request may include any suitable information, including the identity of user 130 (e.g., username or identifier), an indication that the target location is room 110(1), etc.

At operation 310, navigation server 260 provides an indication of a unique identifier to user device 210. As a result, user device 210 may broadcast the unique identifier as user 130 is navigating to room 110(1). At operation 315, navigation server 260 provides an indication of the unique identifier to display device 120(i). Navigation server 260 may also provide, to display device 120(i), other information such as the identity of user 130, an indication that the target location is room 110(1), an indication of navigational information to display when user device 210 is in wireless communication proximity to display device 120(i), etc.

At operation 320, user device 210 broadcasts the unique identifier to any nearby, available/free (e.g., unreserved) display devices. In this example, user device 210 is in wireless communication proximity to display device 120(i). As a result, display device 120(i) obtains the unique identifier from user device 210 and, at operation 325, displays navigational information.

At operation 330, display device 120(i) sends a first ping to user device 210. At operation 335, display device 120(i) obtains a first response to the first ping. At operation 340, display device 120(i) sends a second ping to user device 210. At operation 345, display device 120(i) obtains a second response to the second ping. Display device 120(i) compares the signal strength of the first and second responses to determine whether user 130 is moving/walking away from (e.g., leaving the location of) display device 120(i). For example, if the signal strength of the second response is stronger than that of the first response, display device 120(i) may determine that user 130 is approaching display device 120(i); or, if the signal strength of the second response is the same as that of the first response, display device 120(i) may determine that the distance between user 130 and display device 120(i) is not changing. In this example, the signal strength of the second response is weaker than that of the first response, and therefore display device 120(i) determines that user 130 is moving away from display device 120(i). Thus, user 130 is no longer observing the displayed navigational information, and at operation 350, display device 120(i) clears the navigational information from the display.

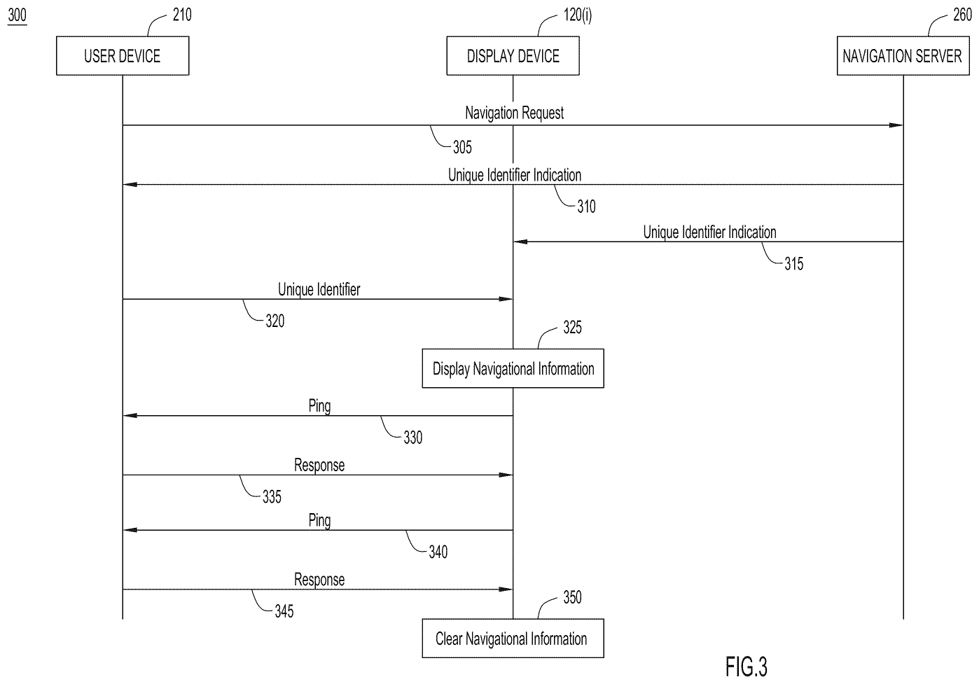

One advantage of the techniques illustrated in FIG. 3 is that display device 120(i) may display the navigational information shortly after obtaining the unique identifier. The delay time until display may be minimized because display device 120(i) has already received or generated the navigational information before display device 120(i) obtains the unique identifier from user device 210. As a result, user 130 may continue moving (e.g., walking) at the same pace, without slowing down, while following the directions according to the promptly displayed navigational information.

For example, display device 120(i) may surface (e.g., display) the navigational information as soon as (e.g., immediately or almost immediately) display device 120(i) determines that user device 210 is in proximity to display device 120(i) (e.g., within five meters). Display device 120(i) may clear the navigational information once the user has moved sufficiently far away (e.g., greater than five meters). The distances at which display device 120(i) displays or clears the navigational information may be adjustable. In one example, display device 120(i) may also generate an audible signal (e.g., beep) when it surfaces the navigational information to draw the attention of user 130 to display device 120(i).

By tracking the ping measurements, display device 120(i) may detect that the user is approaching display device 120(i) and then continuing along toward the target destination (e.g., moving away from display device 120(i)). Display device 120(i) may determine that user 130 is approaching or leaving display device 120(i) based on a small number of pings (e.g., two or three pings). In one example, display device 120(i) may continue to ping user device 210 for some time after display device 120(i) has cleared the navigational information in case user 130 decides to return to display device 120(i). For instance, a decreasing distance between display device 120(i) and user 130 may cause display device 120(i) to re-surface the navigational information.

FIGS. 4A-4C illustrate respective displays 400A-400C configured to guide one or more users to one or more target locations, according to an example embodiment. In these examples, a display device may have previously obtained unique identifier(s) corresponding to the one or more users, and upon obtaining the unique identifier(s) from the user device(s), the display device may generate displays 400A-400C.

In FIG. 4A, a single user (Jane) is attempting to navigate to the Fourier conference room. The navigational information shown in display 400A includes an identification of the user (“Jane”), the target location/destination (“Fourier Conference Room”), and an arrow to direct Jane, with respect to the physical floor/building space, from the location of the display device to the Fourier conference room. The navigational information may be displayed prominently to enable Jane to easily navigate to the Fourier conference room without slowing down.

In FIG. 4B, two users (Jane and Bob) are both separately attempting to navigate to the Fourier conference room. The navigational information shown in display 400B includes an identification of the users (“Jane and Bob”), the target location/destination (“Fourier Conference Room”), and an arrow to direct Jane and Bob, with respect to the physical floor/building space, from the location of the display device to the Fourier conference room. In this example, the navigational information for multiple users proceeding to the same target location may be combined/integrated.

In FIG. 4C, two users (Pam and Bob) are simultaneously attempting to navigate to different target locations: Pam to the Pascal conference room, and Bob to the Fourier conference room. Display 400C is shown in split-screen format, with the navigational information for Pam on the left side of display 400C and the navigational information for Bob on the right. The navigational information for Pam includes an identification of the user (“Pam”), the target location/destination (“Pascal Conference Room”), and an arrow to direct Pam, with respect to the physical floor/building space, from the location of the display device to the Pascal conference room. The navigational information for Bob includes an identification of the user (“Bob”) and an indication that Bob has arrived at the Fourier conference room. Thus, simultaneous navigation for different users may be enabled by tagging the respective navigational information/instructions with the corresponding user identification. The navigational information may include a direction (e.g., an arrow), or indicate that the user has arrived at the target location.

Displays 400A-400C also include button 410. When selected by a user, button 410 enables further display options. In one example, the display device may prompt one or more additional display devices to display additional navigational information (e.g., a floor map). The display device may be connected (e.g., paired) to the additional display device(s), allowing the user to request the display device to escalate the additional navigational information to the additional display device(s). The additional display device may have a larger display than the display device, thereby providing the user with an enlarged view of the additional navigational information (e.g., the floor plan). In one example, the additional display device(s) may be one or more of Cisco Systems, Inc.'s Room OS devices.

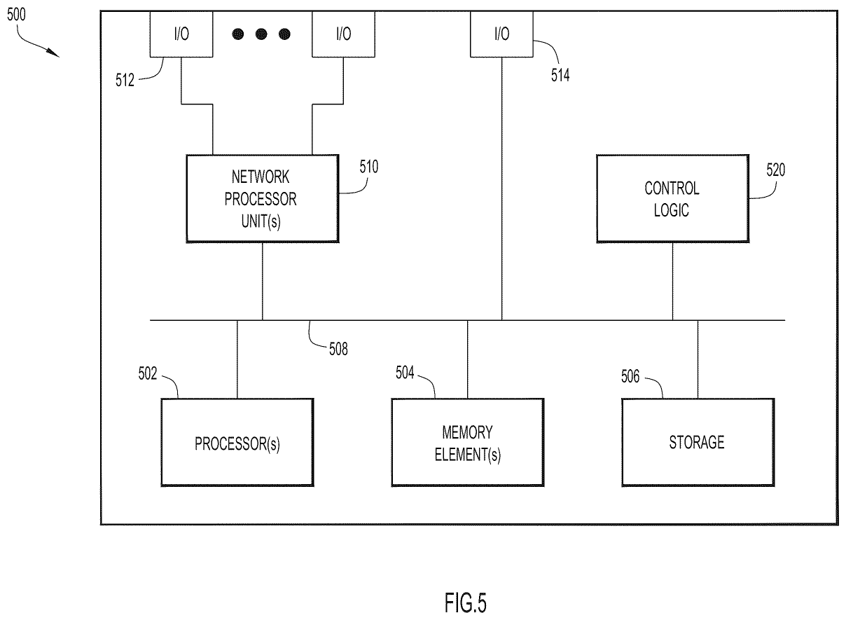

Referring to FIG. 5, FIG. 5 illustrates a hardware block diagram of a computing device 500 that may perform functions associated with operations discussed herein in connection with the techniques depicted in FIGS. 1-3 and 4A-4C. In various embodiments, a computing device, such as computing device 500 or any combination of computing devices 500, may be configured as any entity/entities as discussed for the techniques depicted in connection with FIGS. 1-3 and 4A-4C in order to perform operations of the various techniques discussed herein.

In at least one embodiment, computing device 500 may include one or more processor(s) 502, one or more memory element(s) 504, storage 506, a bus 508, one or more network processor unit(s) 510 interconnected with one or more network input/output (I/O) interface(s) 512, one or more I/O interface(s) 514, and control logic 520. In various embodiments, instructions associated with logic for computing device 500 can overlap in any manner and are not limited to the specific allocation of instructions and/or operations described herein.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 504 and/or storage 506 is/are configured to store data, information, software, and/or instructions associated with computing device 500, and/or logic configured for memory element(s) 504 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with memory elements 504 (or vice versa), or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 510 may enable communication between computing device 500 and other systems, entities, etc., via network I/O interface(s) 512 to facilitate operations discussed for various embodiments described herein. In various embodiments, network processor unit(s) 510 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 512 can be configured as one or more Ethernet port(s), Fibre Channel ports, and/or any other I/O port(s) now known or hereafter developed. Thus, the network processor unit(s) 510 and/or network I/O interfaces 512 may include suitable interfaces for receiving, transmitting, and/or otherwise communicating data and/or information in a network environment.

I/O interface(s) 514 allow for input and output of data and/or information with other entities that may be connected to computing device 500. For example, I/O interface(s) 514 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 520 can include instructions that, when executed, cause processor(s) 502 to perform operations, which can include, but not be limited to, providing overall control operations of computing device 500; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, Random Access Memory (RAM), Read Only Memory (ROM), Erasable Programmable ROM (EPROM), Application Specific Integrated Circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, Digital Signal Processing (DSP) instructions, software [potentially inclusive of object code and source code], etc.) for execution by one or more processor(s), and/or other similar machine, etc. Generally, memory element(s) 504 and/or storage 506 can store data, software, code, instructions (e.g., processor instructions), logic, parameters, combinations thereof, and/or the like used for operations described herein. This includes memory elements 504 and/or storage 506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, Compact Disc ROM (CD-ROM), Digital Versatile Disc (DVD), memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to computing device 500 for transfer onto another computer readable storage medium.

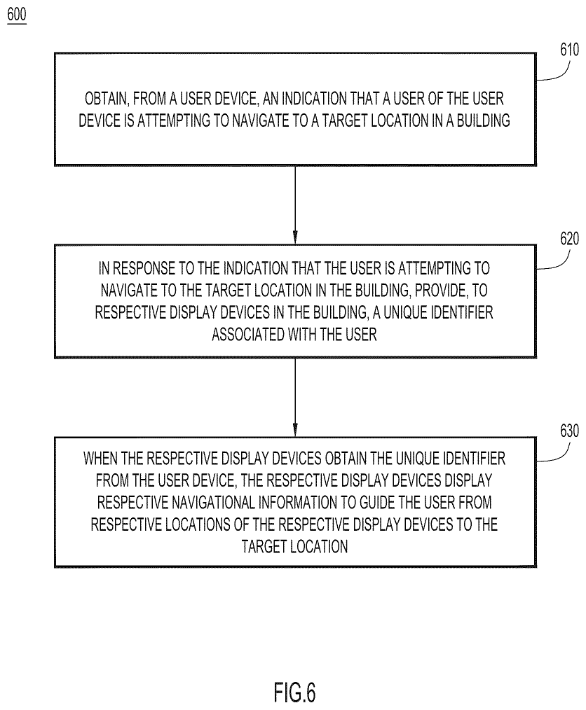

FIG. 6 is a flowchart of an example method 600 for performing functions associated with operations discussed herein. At operation 610, a server (e.g., navigation server 260, FIG. 2) obtains, from a user device, an indication that a user of the user device is attempting to navigate to a target location in a building. At operation 620, in response to the indication that the user is attempting to navigate to the target location in the building, the server provides, to respective display devices in the building, a unique identifier associated with the user. At operation 630, when the respective display devices obtain the unique identifier from the user device, the respective display devices display respective navigational information to guide the user from respective locations of the respective display devices to the target location.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any Local Area Network (LAN), Virtual LAN (VLAN), Wide Area Network (WAN) (e.g., the Internet), Software Defined WAN (SD-WAN), Wireless Local Area (WLA) access network, Wireless Wide Area (WWA) access network, Metropolitan Area Network (MAN), Intranet, Extranet, Virtual Private Network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

In various example implementations, entities for various embodiments described herein can encompass network elements (which can include virtualized network elements, functions, etc.) such as, for example, network appliances, forwarders, routers, servers, switches, gateways, bridges, load-balancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In one form, a method is provided. The method comprises: obtaining, from a user device, an indication that a user of the user device is attempting to navigate to a target location in a building; and in response to the indication that the user is attempting to navigate to the target location in the building, providing, to respective display devices in the building, a unique identifier associated with the user, wherein when the respective display devices obtain the unique identifier from the user device, the respective display devices display respective navigational information to guide the user from respective locations of the respective display devices to the target location.

In one example, the respective display devices obtain the unique identifier from the user device when the user device is in wireless communication proximity to the respective display devices.

In one example, the respective display devices are configured to clear the respective navigational information when the user moves away from the respective display devices.

In one example, the method further comprises: providing, to the respective display devices, an indication of the target location, wherein the respective display devices are configured to determine the respective navigational information based on the indication of the target location.

In one example, the method further comprises: in response to the indication that the user is attempting to navigate to the target location in the building, determining the respective navigational information; and providing, to the respective display devices, respective indications of the respective navigational information.

In one example, the respective display devices are configured to prompt one or more additional display devices to display additional navigational information.

In one example, when the respective display devices obtain multiple unique identifiers from multiple user devices, the respective display devices display respective navigational information to guide multiple users from the respective locations of the respective display devices to multiple target locations.

In one example, the respective navigational information includes respective arrows to direct the user from the respective locations of the respective display devices to the target location.

In another form, a system is provided. The system comprises: a server; and respective display devices in a building, wherein: the server is configured to obtain, from a user device, an indication that a user of the user device is attempting to navigate to a target location in the building, the server is further configured to, in response to the indication that the user is attempting to navigate to the target location in the building, provide, to the respective display devices in the building, a unique identifier associated with the user, and the respective display devices are configured to, when the respective display devices obtain the unique identifier from the user device, display respective navigational information to guide the user from respective locations of the respective display devices to the target location.

In another form, one or more non-transitory computer readable storage media are provided. The non-transitory computer readable storage media are encoded with instructions that, when executed by a processor, cause the processor to: obtain, from a user device, an indication that a user of the user device is attempting to navigate to a target location in a building; and in response to the indication that the user is attempting to navigate to the target location in the building, provide, to respective display devices in the building, a unique identifier associated with the user, wherein when the respective display devices obtain the unique identifier from the user device, the respective display devices display respective navigational information to guide the user from respective locations of the respective display devices to the target location.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

1. A method comprising:
obtaining, from a user device, an indication that a user of the user device is attempting to navigate to a target location in a building;
in response to the indication that the user is attempting to navigate to the target location in the building, providing, to respective display devices in the building, a unique identifier associated with the user;
obtaining at the respective display devices the unique identifier from the user device;
displaying at the respective display devices respective navigational information to guide the user from respective locations of the respective display devices to the target location; and
clearing, based on the user moving away from the respective display devices, the respective navigational information from the respective display devices.

2. The method of claim 1, wherein the respective display devices obtain the unique identifier from the user device when the user device is in wireless communication proximity to the respective display devices.

3. (canceled)

4. The method of claim 1, further comprising:
providing, to the respective display devices, an indication of the target location,
wherein the respective display devices are configured to determine the respective navigational information based on the indication of the target location.

5. The method of claim 1, further comprising:
in response to the indication that the user is attempting to navigate to the target location in the building, determining the respective navigational information; and
providing, to the respective display devices, respective indications of the respective navigational information.

6. The method of claim 1, wherein the respective display devices are configured to prompt one or more additional display devices to display additional navigational information.

7. The method of claim 1, wherein when the respective display devices obtain multiple unique identifiers from multiple user devices, the respective display devices display respective navigational information to guide multiple users from the respective locations of the respective display devices to multiple target locations.

8. The method of claim 1, wherein the respective navigational information includes respective arrows to direct the user from the respective locations of the respective display devices to the target location.

9. A system comprising:
a server; and
respective display devices in a building, wherein:
the server is configured to obtain, from a user device, an indication that a user of the user device is attempting to navigate to a target location in the building,
the server is further configured to, in response to the indication that the user is attempting to navigate to the target location in the building, provide, to the respective display devices in the building, a unique identifier associated with the user,
the respective display devices are configured to, when the respective display devices obtain the unique identifier from the user device, display respective navigational information to guide the user from respective locations of the respective display devices to the target location; and
the respective display devices clear the respective navigational information when the user moves away from the respective display devices.

10. The system of claim 9, wherein the respective display devices are further configured to obtain the unique identifier from the user device when the user device is in wireless communication proximity to the respective display devices.

11. (canceled)

12. The system of claim 9, wherein:
the server is further configured to provide, to the respective display devices, an indication of the target location, and
the respective display devices are further configured to determine the respective navigational information based on the indication of the target location.

13. The system of claim 9, wherein the server is further configured to:
in response to the indication that the user is attempting to navigate to the target location in the building, determine the respective navigational information; and
provide, to the respective display devices, respective indications of the respective navigational information.

14. The system of claim 9, wherein the respective display devices are further configured to prompt one or more additional display devices to display additional navigational information.

15. The system of claim 9, wherein the respective display devices are further configured to, when the respective display devices obtain multiple unique identifiers from multiple user devices, display respective navigational information to guide multiple users from the respective locations of the respective display devices to multiple target locations.

16. The system of claim 9, wherein the respective navigational information includes respective arrows to direct the user from the respective locations of the respective display devices to the target location.

17. One or more non-transitory computer readable storage media encoded with instructions that, when executed by a processor, cause the processor to:
obtain, from a user device, an indication that a user of the user device is attempting to navigate to a target location in a building;
in response to the indication that the user is attempting to navigate to the target location in the building, provide, to respective display devices in the building, a unique identifier associated with the user, wherein when the respective display devices obtain the unique identifier from the user device, the respective display devices display respective navigational information to guide the user from respective locations of the respective display devices to the target location; and
cause the respective display devices to clear the respective navigational information when the user moves away from the respective display devices.

18. The one or more non-transitory computer readable storage media of claim 17, wherein the respective display devices obtain the unique identifier from the user device when the user device is in wireless communication proximity to the respective display devices.

19. The one or more non-transitory computer readable storage media of claim 17, wherein the instructions further cause the processor to:
provide, to the respective display devices, an indication of the target location,
wherein the respective display devices are configured to determine the respective navigational information based on the indication of the target location.

20. The one or more non-transitory computer readable storage media of claim 17, wherein the instructions further cause the processor to:
in response to the indication that the user is attempting to navigate to the target location in the building, determine the respective navigational information; and
provide, to the respective display devices, respective indications of the respective navigational information.

21. The one or more non-transitory computer readable storage media of claim 17, wherein the instructions further cause the processor to:
obtain multiple unique identifiers from multiple user devices; and
cause the respective display devices to display respective navigational information to guide multiple users from the respective locations of the respective display devices to multiple target locations.

22. The one or more non-transitory computer readable storage media of claim 17, wherein the instructions further cause the processor to prompt one or more additional display devices to display additional navigational information.
